(19) United States
(12) Patent Application Publication
(10) Pub. No.: US 2004/0237752 A1
(43) Pub. Date: Dec. 2, 2004

(54) Interreactive components for enharmonic guitar

(76) Inventor: T. Wilfred Pye, Houma, LA (US)

Correspondence Address: T. Wilfred Pye, 304 Fairmont Drive, Houma, LA, 70360, US

(21) Appl. No.: 10/449,165

(22) Filed: Jun. 2, 2003

(51) Int. Cl. G10D 3/14

(52) U.S. Cl. 84/312 R

(57) ABSTRACT

This application relates to the field of music, and more specifically to stepped pitch stringed instruments such as guitars crafted for tone generation to a particular fret spacing arrangement, a particular placement of the bridge, and the use of pitch altering devices for the strings. The preferred embodiment implements a series of frets placed at traditional length ratio spacings for a portion of the neck combined with another series of frets not adhering to the original length ratio. This double series of frets is used in tandem with a micropitch alteration device for the strings. The bridge is crowded closer to the nut than the prior art distance historically producing standard 100 cent intervals between the initial twelve chromatic frets. This crowded bridge is useful for allowing the use of alternate intonation schemes by way of the strings when fretted and sounded.

### FIELD OF THE INVENTION

This application relates to the field of music, and more specifically to stepped pitch stringed instruments such as guitars crafted for tone generation to a particular fret spacing arrangement, a particular placement of the bridge, and the use of pitch altering devices for the strings. The preferred embodiment implements a series of frets placed at traditional length ratio spacings for a portion of the neck combined with another series of frets not adhering to the original length ratio. This double series of frets is used in tandem with a micropitch alteration device for the strings. The bridge is crowded closer to the nut than the prior art distance historically producing standard 100 cent intervals between the initial twelve chromatic frets. This crowded bridge is useful for allowing the use of alternate intonation schemes by way of the strings when fretted and sounded.

### DESCRIPTION OF THE RELATED ART

With a standard guitar neck, the distance between successive frets diminishes as the bridge is approached relative to the nut end. These identically angled frets converge closer and closer to each other on the neck moving away from the nut end, losing about 05.6% of the separation distance at each stage. This shortening of fret separation is a long described art. In this paper a nut is considered the “zero” fret, because it represents the longest graduated point of a string's vibration farthest away from the bridge end. In such a guitar, the theoretical distance from the zero fret to the 1st fret is twice the physical distance from the 12th fret to the 13th fret.

The art of these traditional instruments describes the 12th chromatic fret positioned at the mid-point of the string's sounding length between the zero fret and bridge. In this situation the desired effect is an even sharping of the open string pitch by 100 cents of pitch as the player ascends step by step along the frets to eventually reach the 12th fret, which also sounds an octave higher repeat 1200 cents above the pitch of the open string pitch.

However, if the bridge is sharped closer to the zero fret than is prescribed relative to the calculated fret distances of a standard guitar, the equal temperament value from fret to fret is increased from 100 cents to a sharped value greater than 100 cents. This is herein termed a “crowded” bridge. With a crowded bridge, the 12th fret will no longer be at the midpoint, and pure octave repeats of the open pitch is thwarted because the offset error from fret to fret is cumulative, and the 12th fret gives a sharp pitch.

There is no prior art known to the inventor relative to the use of a crowded bridge to cause an equal temperament semi-tone value equal to or greater than 101 cents and less than 104 cents.

### SUMMARY OF THE INVENTION

The goal of the invention is an enharmonic musical instrument with one or a plurality of strings able to produce a diversity of non-standard intervals.

A guitar with a neck having a series of frets in standard offsets losing about 05.6% of the physical separation distance has a claimed novel status when the bridge is crowded to produce an ascending frequency value between adjacent frets equal to or greater than 101 cents but less than 104 cents.

In the preferred embodiment a double series of frets is employed. The second series of frets beginning at the 12th fret is flatted sufficiently to return this second series to being octave repeats of the initial lower tonality frets. When carried forward for comparison, this means the 13th fret also gives an octave pitch relative to the pitch of the 1st fret, and the 14th fret also gives an octave repeat relative to the 2nd fret, and so forth.

The crossover position is where the frets end the even maintenance of the initial 05.6% separation, and begin to ascend as another offset series of frets also at a 05.6% separation. This crossover position may be modified to allow the initial series of frets to continue past the 12th fret position. In other words, at one or more locations the original series of frets co-exists with the second series of frets with a microtonal purpose. This means that the merged location can allow a player to either sound the initial series of pitches, or alternately to sound the second series of pitches as desired. Pivoting structure will be shown that can elevate the more flat of the two competing fret locations on command. The pitch derived from the flatter of the two frets can only be employed by the player as an alternative to the sharper value. Thus there is a microtonal relationship for the two competing fret locations whereby either of two different pitches can be selected. These two pitches only differ by an interval value at or between 12 and 48 cents.

The actual size of this pitch value, termed herein the “jump” pitch value, depends on the cent value separating the frets of the initial (lower) fret series. For example, if the initial series is at 103 cents, by the 12th fret the actual pitch sounded is 36 cents sharp to the correct octave value (3 cents times 12). Thus, in the 103 cent example, the jump value is 36 cents. To correct this, the 12th fret commencing the second series must be physically in the neck at a spot able to sound the desired octave to the open string value.

Another modification to the instrument of the preferred embodiment is the presence of cam structure to on command tighten or lessen the tension of the strings to force the strings to provide the jump value on any one of the initial (lower) fret series. For instance, rather than have to employ the above mentioned pivoting structure at the 12th fret to flat the octave pitch to a true octave repeat, the cam structure can lessen the tension on the strings the required 12 or more cents to a desired jump value. A re-triggering of the cam structure to the higher tension can return the strings to the initial value.

In the preferred embodiment, the instrument has both methods to choose between the two pitches for the critical cross-over fret locations: a pivoting double fret apparatus and a user operated cam to uniformly sharp or flat the string pitches by a predetermined corrective microtonal jump value.

### BRIEF DESCRIPTION OF DRAWINGS

FIG. 1 is a comparison of a standard guitar on the left with a guitar on the right having a crowded bridge.

FIG. 2 is also a comparison of a standard guitar on the left with a guitar on the right having a crowded bridge, but additionally having a second series of upper register frets flatted to provide octave repeats for the initial frets.

FIG. 3 is as in FIG. 2 but additionally having a cam device for altering the pitch of the strings by a microtonal cent value, and having two frets per location at both the 12th and 13th fret locations.

FIG. 4 is a blow-up perspective of the cam device showing the torque lever unactivated relative to one string of a guitar.

FIG. 5 is as in FIG. 4 with the cam device showing the torque lever activated.

FIG. 6 is a perspective of the 12th fret location of FIG. 3 showing the two microtonal frets that can be selected on command by a performer.

FIG. 7 is a side view of the two microtonal frets of FIG. 6 showing a preview of a moving fret design. A depressing force on a plate surface can pivot the nearest of the two frets into a higher elevation sufficient to engage a string cleanly. The normally uplifted fret is submerged by this action (not shown).

### DETAILED DESCRIPTION OF THE INVENTION

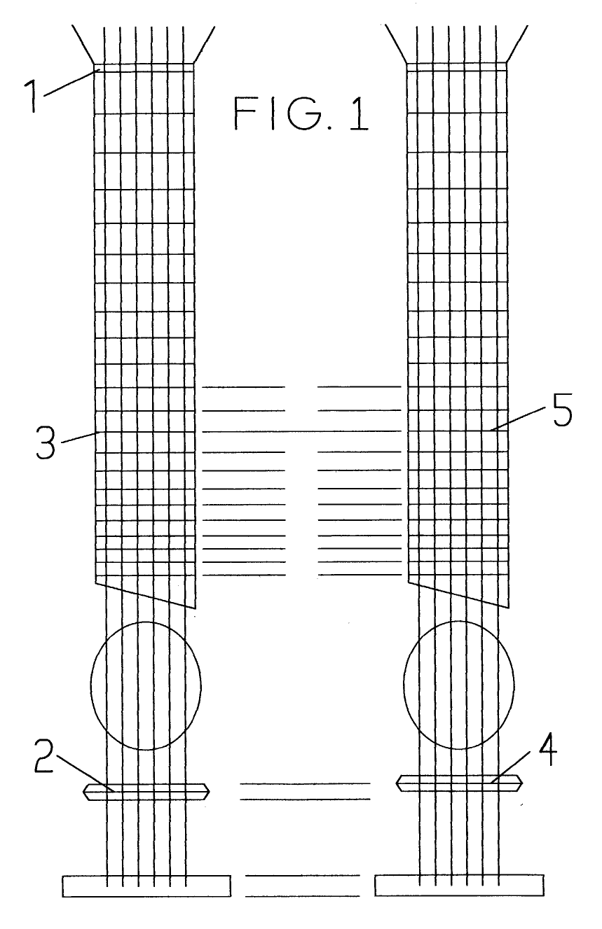

FIG. 1 shows a standard prior art guitar on the left having the strings held at tension between a nut or zero fret 1 and a bridge 2. At the midpoint of the string sounding length is the twelfth fret 3, which allows an octave pitch of an open string to be sounded. In comparison the guitar on the right has a crowded bridge 4. If the open string is subsequently fretted at twelfth fret 5, the pitch is too sharp to be an octave to the open string's sounding frequency.

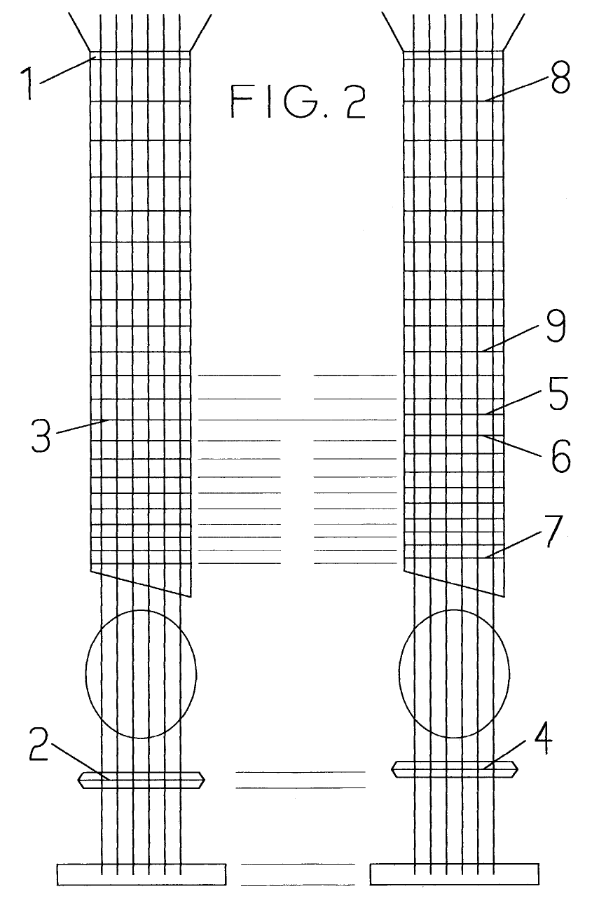

FIG. 2 has the twelfth fret to the twenty-first fret of the guitar on the right all evenly flatted in placement to allow correct octave repeats to the lower values. For instance, the thirteenth fret 6 provides an octave pitch to the pitch allowed by first fret 8, and twenty-first fret 7 allows an octave pitch to the pitch allowed by the ninth fret 9.

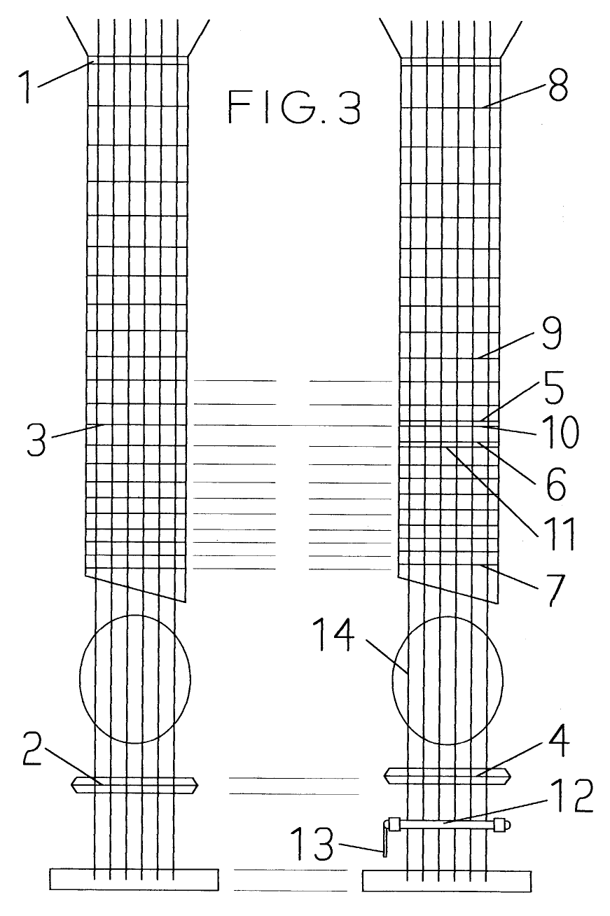

FIG. 3 is similar to FIG. 2 but also shows enharmonic fret 10 close to the twelfth fret 5, and also shows enharmonic fret 11 close to the thirteenth fret 6. A rod shaped cam 12 has all the strings such as string 14 each passing through a hole provided for that purpose. Alternate movement of lever bar 13 can increase or drop tension on the effected strings by a prescribed amount.

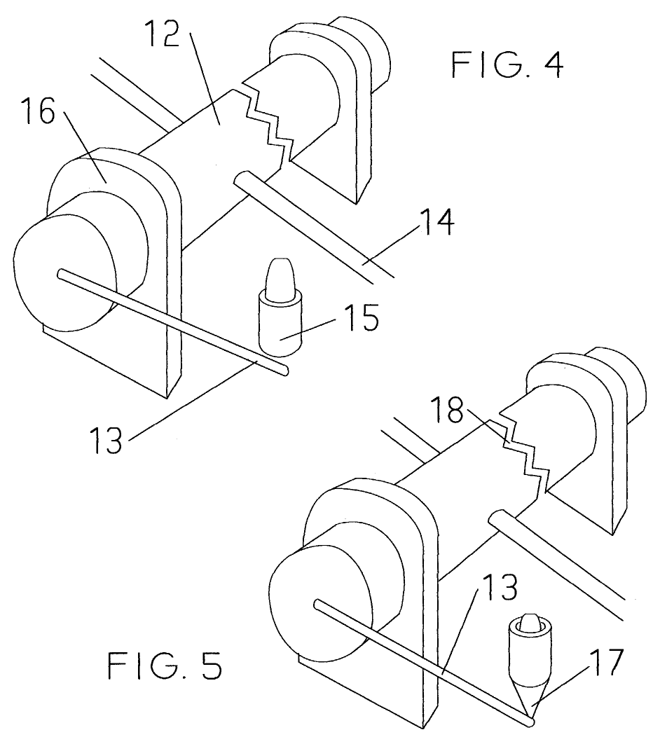

FIG. 4 shows the up position of cam lever 13. An immobilized force switch 15 can deliver downward movement of the lever in the manner of a ball-point pen action, which torques string 14 to greater tightness. A second force on switch 15 would let the upper plunger elevate itself again and reduce the tension of string 14. The cam rod 12 rotates freely in brace 16.

FIG. 5 shows the after effect of switch 15 being depressed. Lower plunger 17 has emerged and forced lever 13 down to a locked position. The drawing is reduced in perspective by imaginary break 18 to allow the action to be seen with greater clarity. In normal situations there would be five more strings passing through cam rod 12, which are not shown in this blow-up.

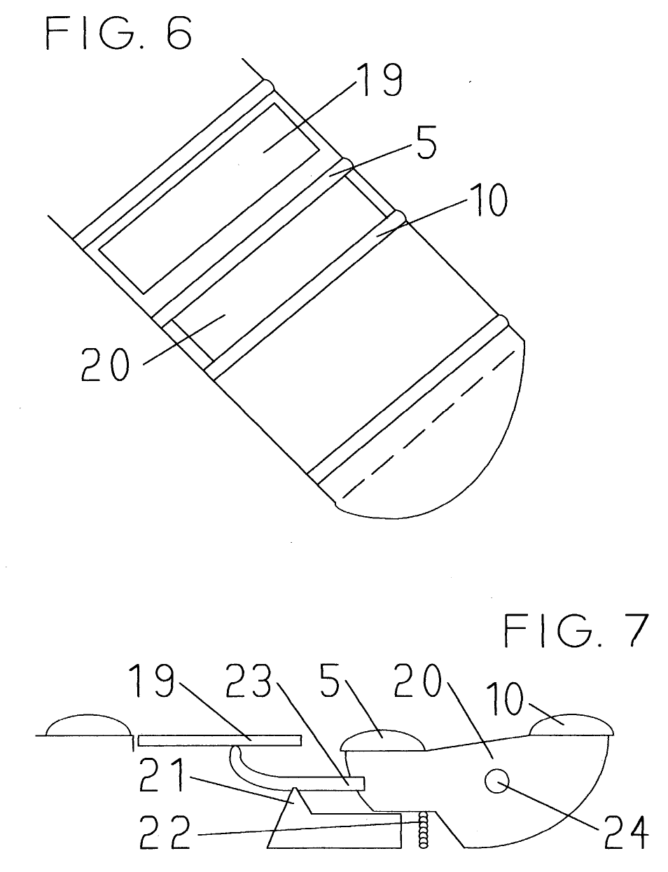

FIG. 6 is a blow-up of an upper perspective of the two enharmonic frets 5 and 10 as seen in FIG. 3. Between them lies a rotational cylinder 20 to which both fret 5 and fret 10 are secured. A floating plate 19 is a trigger mechanism used to act upon cylinder 20. The guitar neck is abbreviated in length, and this is indicated by the hashed line for the nearer end.

FIG. 7 shows a side cut-a-way view of the fret mechanism of FIG. 6. A pivot wedge 21 also serves as a stop block to terminate the downward flight of cylinder 20 responding to the pull of spring 22. Any downward force on plate 19 is transferred in a see-saw action over wedge 21 to lift rod 23. The uplift generated into rod 23 is transferred up into cylinder 20 causing it to spin clockwise around fixed nail 24. This uplift causes fret 5 to elevate and fret 10 to descend relative to the fretboard of the guitar. A normal fretting action where the finger pressure is concentrated on fret 5 leaves fret 10 at its normal high elevation, and this produces a sharper microtonal frequency than the slightly flatter frequency provided by fret 5 when it is selected for use. Spring 22 normally keeps fret 10 elevated at the height of the other nearby frets, while fret 5 is submerged. When activated, the uplift action overcomes spring 22 and allows fret 5 to rise to the proper desired height.

### SUMMARY

Although this invention is one and the same thing, because of the interchangeable nature of the parts on a guitar, some would choose to claim a guitar with a 05.6% series of frets on the guitar neck used in combination with a crowded bridge. This claimed guitar may be subsequently employed in combination with various improvements listed below.

To others the invention may be considered to be a double 05.6% series of frets on a guitar neck; whereby this double series of fretting structure may be used in combination with either or both a crowded bridge and interchangeable movable microtonal frets. With or instead of the previous, the invention may be combined with microtonal sharping structure for the guitar strings. The sharping structure is employed by a musician to accurately drop or lift the tension on the affected strings by a set portion of a semi-tone. In the preferred embodiment the invention has the double fret series employed with all three of the combinations given in this paragraph; a crowded bridge, movable microtonal frets, and sharping structure.

To others the invention may be considered to be microtonal sharping structure for guitar strings employed to accurately drop or lift the tension on a given string by a set portion of a semi-tone falling between 12 and 48 cents. As such, this sharping structure may be subsequently employed in combination with either a 05.6% series of frets on a guitar neck fitted in conjunction with a crowded bridge, or with movable microtonal frets.

In the preferred embodiment the jump value is a value between 23 and 24 cents. Additionally, the invention claims jump values from 12 to 48 cents as lesser embodiments. Other ways exist to move frets than rotational means.

The utility of instruments of this nature is best realized for example when the six strings of a guitar are tightened or loosened to alternate values than provided by the common E-A-D-G-B-E tuning. A good example of this is double dropped “D” tuning which is D-F#-D-G-B-E. However, as consistent with the nature of a guitar, the user may torque the strings to any combination of frequencies desired. Intonation values (as selected from open string to open string) providing an interval combination sympathetic to the sharped value generated between frets is suggested, but not described herein. This is because the myriad of ways that a user may torque the tuning pegs falls outside the material scope of the invention. The common intonation system using 100 cents between intervals to tune the pitches from open string to open string is not a good choice herein. This is because the open string frequency combinations are not sympathetic to the sharper 101 to 104 cents between intervals recommended for the instant structure.

This invention should not be confined to the embodiments described, as many modifications are possible to one skilled in the art. This paper is intended to cover any variations, uses, or adaptations of the invention following the general principles as described and including such departures that come within common practice for this art and fall within the bounds of the claims appended herein.

I claim:

1. A guitar with a crowded bridge,
said guitar having a neck with a plurality of frets ascending in a manner such that the distance between adjacent frets loses 05.6% of separation, and whereby the ascending frequencies of a string of said guitar using said adjacent frets as contact locations yields an interval distance between 101 and 104 cents of value, where 1200 cents of value is the difference between an open string frequency value and an octave higher repeat of said open value,
said crowded bridge shortening the sounding length of said string such that the frequency sounded by the twelfth chromatic fret in the musical series of said frets is a value sharp to said octave repeat of 1200 cents by a value falling at or between 1212 cents and 1248 cents.

2. A guitar with a crowded bridge as in 1,
with said frequency value falling at or between 1218 and 1242 cents.

3. A guitar with a crowded bridge as in 1,
with said frequency value falling at or between 1222 and 1238 cents.

4. A guitar with a crowded bridge as in 1, together with user activated sharping structure in contact with said string,
said sharping structure when activated or deactivated respectively increasing or decreasing the tension on said string by a set portion of a semi-tone falling at or between 12 and 48 cents of frequency value.

5. A guitar with a crowded bridge as in 4,
where said user activated sharping structure is a lever activated cam.

6. A guitar with a crowded bridge as in 1,
said guitar with said neck having a first and second series of frets, with each of said two series of frets following the placement rules of 05.6% of separation distance lost between ascending adjacent frets,
said guitar neck having a zero fret which is sometimes termed a nut in other literature,
with said first series of frets numbering at minimum eight in addition to said zero fret, and said second series numbering at least three frets,
with ascending adjacent members of said first series of frets generating an even increase of pitch for said string by a frequency value at or between 101 and 104 cents,
with said second series serving as octave repeats to specific fret values of said first fret series such that one fret of said three frets is placed to enable an octave repeat of the open sounding frequency of said string, whereby said one fret of said three frets is placed at a smaller and therefore flatted location on said neck relative to said first series of frets than predicted by said rules of 05.6% separation governing the placement of said first series of frets.

7. A guitar with a crowded bridge as in 6, with said one fret of said three frets together with an enharmonic fret encased in the upper surface of movable structure, said enharmonic fret appearing at a location on said neck to allow a frequency value as predicted by said rules of 05.6% separation relative to said first series of frets,
whereby said movable structure allows said one fret of said three frets to be elevated to a proper level to engage said string as determined either by the finger pressure of a musician or by other command of said musician, said pressure or said command submerging the portion of said movable structure containing said enharmonic fret to a lower level than the original level before said pressure was applied.

8. A guitar neck having a first and second series of frets,
with each of said two series of frets following the placement rules of 05.6% of separation distance lost between adjacent frets,
said guitar neck either having a zero fret which is sometimes termed a nut in other art or having a position for later placement of said zero fret,
with said first series of frets numbering at minimum eight not counting said zero fret, and said second series numbering at least three frets,
with all three frets of said second series placed at locations on said neck at flatter positions than the theoretical locations predicted by said placement rules of 05.6% separation if said first series of eight frets had been accurately extended by additional positions.

9. A guitar neck as in 8, where said flatter positions maintain a distance greater than two millimeters from said theoretical locations.

10. A guitar neck as in 8, where said minimum number of frets is eleven.

11. A guitar neck as in 8,
said guitar neck in combination with said zero fret and a guitar having a plurality of strings and a bridge,
with said bridge in crowded position such that the frequencies of one of said strings as sounded along and in contact with adjacent frets of said first series of frets ascend by a sharped value at or between 101 and 104 cents,
with said flatter positions of said three frets of said second series at particular locations on said neck to enable said string to sound approximate octave repeats of frequencies generated either by certain members of said first series of frets or by said zero fret.

12. A guitar neck as in 8,
said guitar neck in combination with said zero fret and a guitar having a plurality of strings, a bridge, and user-activated frequency sharping structure in contact with said strings,
said sharping structure when activated or deactivated respectively increasing or decreasing the tension on said strings by a set portion of a semi-tone falling at or between 12 and 48 cents of frequency value.

13. A guitar neck as in 12,
where said user-activated frequency sharping structure is a lever activated cam.

14. A guitar neck as in 8,
with at minimum one fret of said three frets together with an enharmonic fret encased in the upper surface of movable structure, said enharmonic fret appearing at a location on said neck to allow a frequency value as predicted by said rules of 05.6% separation relative to said first series of frets such that said enharmonic fret is in correct placement on said neck to be accurately described as a further member of said first series of frets,
whereby said movable structure allows said one fret of said three frets to be elevated to a proper level to engage said string as determined either by the finger pressure of a musician or by other command of said musician, said pressure or said command submerging the portion of said movable structure containing said enharmonic fret to a lower level than the original level before said pressure was applied,
whereby a second application of said pressure or said command will return or allow the return of said enharmonic fret to the unactivated elevation together with the simultaneous loss of elevation of said one fret of said three frets.

15. User-activated frequency sharping structure suitable to be placed in contact with a plurality of strings of a guitar,
said strings held at tension between the bridge and zero fret of said guitar where said zero fret is sometimes termed a nut in other literature,
said user-activated sharping structure when activated or deactivated respectively increasing or decreasing the tension on said strings by a set portion of a semi-tone falling at or between 12 and 48 cents of frequency value.

16. User-activated frequency sharping structure as in 15,
with said portion of said semi-tone falling at or between 22 and 38 cents of frequency value.

17. User-activated frequency sharping structure as in 15,
where said user-activated frequency sharping structure is a lever activated cam.

18. User-activated frequency sharping structure as in 15,
with said bridge of said guitar in crowded position such that the measured frequencies of said strings as sounded along and in contact with the adjacent frets of said guitar ascend by a sharped value at or between 101 and 104 cents, where 1200 cents of value is the difference between an open string frequency value and an octave higher repeat of said open value.

19. User-activated frequency sharping structure as in 15,
said guitar with a neck having a first and second series of frets, with each of said two series of frets following the placement rules of 05.6% of separation distance lost between adjacent frets,
said guitar neck having a zero fret which is sometimes termed a nut in other literature,
with said first series of frets numbering at minimum eight in addition to said zero fret, and said second series numbering at least three frets,
with said bridge in crowded position such that ascending adjacent members of said first series of frets generate an even increase of pitch for said strings by a frequency value at or between 101 and 104 cents,
with said second series of frets serving as octave repeats to specific fret values of said first series of frets such that one fret of said three frets is placed to enable an octave repeat of the open sounding frequency of said strings, whereby said one fret of said three frets is placed at a smaller and therefore flatted location on said neck relative to said first series of frets than predicted by said rules of 05.6% separation governing the placement of said first series of frets.

20. User-activated frequency sharping structure as in 19,
with said one fret of said three frets together with an enharmonic fret encased in the upper surface of movable structure, said enharmonic fret appearing at a location on said neck to allow a frequency value as predicted by said rules of 05.6% separation relative to said first series of frets,
whereby said movable structure allows said one fret of said three frets to be elevated to a proper level to engage said string as determined either by the finger pressure of a musician or by other command of said musician, said pressure or said command submerging the portion of said movable structure containing said enharmonic fret to a lower level than the original level before said pressure was applied,
whereby a second application of said pressure or said command will return or allow the return of said enharmonic fret to the unactivated elevation together with the simultaneous loss of elevation of said one fret of said three frets.
